(19) United States
(12) Patent Application Publication
(10) Pub. No.: US 2023/0156286 A1
(43) Pub. Date: May 18, 2023

(54) DYNAMIC STREAMING INTERFACE ADJUSTMENTS BASED ON REAL-TIME SYNCHRONIZED INTERACTION SIGNALS

(71) Applicant: Flustr, Inc., Irvine, CA (US)

(72) Inventors: Miurika Valery, Inglewood, CA (US); Shawn Janik, Inglewood, CA (US); Lih Chang, Irvine, CA (US)

(21) Appl. No.: 17/990,378

(22) Filed: Nov. 18, 2022

Related U.S. Application Data
(60) Provisional application No. 63/280,952, filed on Nov. 18, 2021.

(51) Int. Cl. H04N 21/472; H04N 21/845; H04N 21/439; H04N 21/478

(52) U.S. Cl. CPC H04N 21/472; H04N 21/8456; H04N 21/439; H04N 21/478

(57) ABSTRACT

Various embodiments provide for dynamic streaming interface adjustments based on real-time synchronized interaction signals.

### CROSS-REFERENCE TO RELATED APPLICATIONS

The present application claims priority to U.S. Provisional Application Ser. No. 63/280,952, titled “DYNAMIC STREAMING INTERFACE ADJUSTMENTS BASED ON REAL-TIME SYNCHRONIZED INTERATION SIGNALS,” filed Nov. 18, 2021, the contents of which are incorporated herein by reference in their entirety for all purposes.

### BACKGROUND

Various conventional systems enable consumption of live-stream content by way of mobile devices. However, such systems suffer from various shortcomings related to technological drawbacks and limitations, as well as lack of meaningful mechanisms for user interaction. Moreover, such systems do not provide for meaningful interactions with the live-stream content after the live-stream has ended. Through applied effort, ingenuity, and innovation, solutions to improve existing systems have been realized and are described in connection with embodiments of the present invention.

### BRIEF SUMMARY

In general, various embodiments of the present disclosure provide methods, apparatus, systems, computing devices, computing entities, and/or the like for dynamic streaming interface adjustments based on real-time synchronized interaction signals.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice embodiments of the present invention.

FIG. 2 provides an example interface adjustment computing entity in accordance with some embodiments discussed herein.

FIG. 3 provides an example client computing entity in accordance with some embodiments discussed herein.

FIGS. 4A-4B depict example operations for use with embodiments of the present disclosure.

FIG. 5 depicts an example data flow diagram in accordance with embodiments of the present disclosure.

FIG. 6 depicts an example data flow diagram in accordance with embodiments of the present disclosure.

FIG. 7 depicts an example interface layout for use with embodiments of the present disclosure.

FIGS. 8A, 8B, 8C, 8D, 8E, and 8F depict example interfaces renderable according to embodiments of the present disclosure.

### DETAILED DESCRIPTION

Various embodiments of the present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. OVERVIEW AND TECHNICAL IMPROVEMENTS

As described in greater detail below, various embodiments of the present disclosure provide for dynamic streaming interface adjustments based on real-time synchronized interaction signals.

Existing systems or solutions may enable simplistic consumption of streaming content, however existing systems do not provide for meaningful quantification of interaction by multiple client computing entities in real time. That is, existing systems may provide for live streaming of a video and its associated audio, and devices consuming (e.g., receiving and viewing) the video and its associated audio may be able to provide a reaction to the content (e.g., by way of a like or a comment), however, the reactions to the content are not quantified in a meaningful way such that they can, in real time, impact an outcome of the live video. Further, timestamps associated with the reactions are not synchronized such that interface elements associated with the reactions can be modified in real-time during or even after the live streaming of the content. These drawbacks are related not only to design defects of existing systems, but also technological limitations associated with streaming of content to a large number of remote computing devices, gathering feedback or reactions from the remote computing devices, processing the data, and providing interface adjustments during a streaming session while the reaction data is still relevant or meaningful. Existing systems do not make efficient use of computing resources in order to overcome the aforementioned challenges.

Embodiments herein solve the aforementioned problems and more by receiving and transmitting content as multiple, independent, data streams, to client computing devices such that the multiple, independent data streams may be synchronized and rendered/played back upon receipt by the client computing devices. Such independent transmission streams not only provide for more control at the client computing devices (e.g., the ability to mute an audio stream), but also protect seamless interface streaming sessions against issues with poor connectivity or bandwidth. That is, transmission streams that include all of the data for rendering and playback at a given client computing device may result in poor quality or unreliable rendering or playback due to any slight reduction in network quality or connectivity at any stage of the transmission. Embodiments herein do not suffer from such drawbacks.

Embodiments herein further provide for a live, meaningful quantification and visual representation of crowd sentiment (e.g., based on user interaction by way of interface interaction signals) associated with one or more video/audio streams of an interface streaming sessions. That is, embodiments herein go beyond mere display of static reactions (e.g., emojis or other reactions) to determine timestamp specific sentiment so that visual representation of sentiment (e.g., based on user interaction) can be specifically associated with a given moment (e.g., or timestamp) or a specific video stream of multiple video streams rendered via a user interface. Not only do existing systems merely display static reactions such that it is impossible to associate a rendering of a static reaction with any given timestamp, the static reactions are not necessarily associated with a specific video stream or interface element of multiple video streams or interface elements being rendered. Accordingly, it is impossible for a visual representation of sentiment to be properly associated with a specific point in time based on common timestamps.

Embodiments herein further provide for dynamic adjustment of an impact a consumer may have on a visual representation of live or synchronized crowd sentiment associated with a video stream. That is, embodiments herein go beyond mere static reactions (e.g., emojis, likes, hearts, and the like) which are a binary reaction (e.g., the emoji or like or heart is selected or it is not selected) to enable weighting of interface interaction signals based on a myriad of criteria, including a number of client computing devices currently consuming the interface streaming session. That is, a single client computing entity may have an impact on the visualization of crowd sentiment, but only so much impact as is allotted to the client computing entity depending on how many other devices are participating in (or have participated in) the interface streaming session. Embodiments herein further dynamically adjust the weighting or impact an individual client computing entity may have on the visualization of crowd sentiment during an interface streaming session when client computing entities join or leave the interface streaming session.

Embodiments herein further enable client computing entities to consume interface streaming sessions after the interface streaming sessions have completed, while also enabling the client computing entities to have an impact on an outcome of the interface streaming session.

Embodiments herein further enable switching of a user from what may be referred to as an MMO (massively multiplayer online game) mechanic or environment to a single player mechanic or environment seamlessly without requiring changes to the user interface or overall system design.

### II. DEFINITIONS

The terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The terms “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client device,” “computing device,” “network device,” “computer,” “user equipment,” “client computing entity,” “mobile device,” and similar terms may be used interchangeably to refer to a computer comprising at least one processor and at least one memory. In some embodiments, the client device or client computing entity may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client device” may refer to computer hardware and/or software that is configured to access a component made available by a server. The server is often, but not always, on another computer system, in which case the client accesses the component by way of a network. Embodiments of client devices may include, without limitation, smartphones, tablet computers, laptop computers, personal computers, desktop computers, enterprise computers, and the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

The term “circuitry” may refer to: hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The term “application,” “app,” or similar terms refer to a computer program or group of computer programs designed for use by and interaction with one or more networked or remote computing devices. In some embodiments, an application refers to a mobile application, a desktop application, a command line interface (CLI) tool, or another type of application. Examples of an application comprise workflow engines, component desk incident management, team collaboration suites, cloud components, word processors, spreadsheets, accounting applications, web browsers, email clients, media players, file viewers, videogames, and photo/video editors. An application can be supported by one or more components either via direct communication with the component or indirectly by relying on a component that is in turn supported by one or more other components.

The term “interface streaming session” refers to a combined streaming experience involving distribution of multiple video and audio streams, each originating from distinct client computing entities, and rendering of the multiple video and audio streams by a plurality of remote client computing entities such that graphical interface elements representing aggregated sentiment (e.g., based at least in part on consumption count and interaction signals received from the plurality of remove client computing entities) are presented in real time during the combined streaming experience. The graphical interface elements representing aggregated sentiment are overlaid in real time over the multiple video streams rendered by the client computing entities and are carefully generated based upon signals received as synchronized with timestamps throughout the interface streaming session.

The term “video interface element” refers to a one or more graphical user interface elements configured to facilitate a visualization and/or human interpretation of data associated with the one or more video streams via an electronic interface. In one or more embodiments, a video interface element may additionally or alternatively be formatted for transmission via one or more networks. In one or more embodiments, a video interface element may include one or more graphical elements and/or one or more textual elements.

The term “sentiment interface element” refers to one or more graphical user interface elements used by a graphical user interface or display device to represent a programmatically generated quantification of sentiment generated based at least in part on interface interaction signals associated with a given timestamp or series of timestamps associated with an interface streaming session. The programmatically generated quantification of sentiment may be considered a representation of crowd sentiment associated with content of the interface streaming session at a given timestamp or series of timestamps. The programmatically generated quantification of sentiment may be based at least in part on weight values associated with interface interaction signals. In embodiments, the sentiment interface element may be associated with a single instance of sentiment or a single instance of interface interaction signal (e.g., as opposed to an aggregation of interface interaction signals).

The term “weight value” refers to a programmatically, configurable, or pre-defined weighting applied to one or more interface interaction signals when determining a size or timing of a sentiment interface element, a health point interface score, a health point interface element, and/or a programmatically generated quantification of sentiment. Weight values utilized in generating a particular score may be defined according to a consumption count at any given timestamp associated with an interface streaming session.

The term “health point interface element” refers to one or more graphical user interface elements used by a graphical user interface or display device to represent a health point interface score which is generated based at least in part on interface interaction signals associated with a given timestamp or series of timestamps associated with an interface streaming session as well as a remaining duration of the interface streaming session.

The term “health point interface score” refers to a programmatically generated quantification of aggregated sentiment, based at least in part on aggregated interface interaction signals and associated weight values, associated with a video stream of an interface streaming session. In embodiments, a health point interface score may be generated based at least in part on a difference between a maximum health point interface score (e.g., a starting health point interface score for each video stream of a plurality of video streams of an interface streaming session) and a current health point interface score (e.g., at a particular timestamp during the interface streaming session duration), or between the current health point interface score and a minimum or maximum health point interface score (e.g., such that the health point interface score is considered fully depleted or maximized at a terminal point representing a minimum or maximum health point interface score) in view of a remaining time duration associated with the interface streaming session as well as a consumption count at a given timestamp. That is, a health point interface score may be configured such that it may be increased or decreased (e.g., adjusted) based on interface interaction signals (e.g., among the other parameters and conditions described herein) toward a terminal point of a health point interface element (e.g., a maximum or a minimum). Accordingly, a health point interface element may present an ever decreasing health point interface score toward a full depletion of the health point interface score in embodiments herein (or vice versa).

The term “interface streaming session start timestamp” refers to a network timestamp associated with when an interface streaming session associated with a particular interface streaming session identifier commences or begins.

The term “interface streaming session end timestamp” refers to a network timestamp associated with when an interface streaming session associated with a particular interface streaming session identifier ends.

The term “interface streaming session duration” refers to an intended or selected duration of network time during which an interface streaming session is active (e.g., streaming or rendering).

The term “remaining time duration” refers to a duration of network time remaining in an interface streaming session at a given timestamp, where the remaining time duration is calculated based at least in part on the interface streaming session start timestamp and the interface streaming session duration.

The term “video stream” refers to video data configured for streaming or transfer such that steady and continuous processing and presentation of the video data is enabled at a client computing entity. In embodiments, a video stream includes a frame sequence having a plurality of video frames arranged in sequential order and each associated with a unique timestamp.

The term “audio stream” refers to audio data configured for streaming or transfer such that steady and continuous processing and playback of the audio data is enabled at a client computing entity. In embodiments, an audio stream includes an audio sequence comprising a plurality of audio snippets arranged in a same sequential order as a plurality of video frames of a video with which the audio stream is associated, and each audio snippet is associated with a unique timestamp.

The term “timestamp” refers to one or more items of data identifying a point in network time when a certain event occurred. In embodiments, a timestamp may include a date, a time of day, and may be accurate to a small fraction of a second. It will be appreciated that format and/or representation of timestamps is not limited herein.

The term “interface interaction signal” refers to an electronic signal representative of an electronic interaction with a rendering of a video stream via a display device of a client computing entity. In embodiments, an electronic interaction represents a swipe or touch contact associated with a particular region of the display device of the client computing entity.

The term “outcome interaction signal” refers to an electronic signal representative of an electronic interaction with a rendering of a video stream via a display device of a client computing entity, where the electronic interaction represents an outcome selection made by a user of the client computing entity. In embodiments, an electronic interaction represents a swipe or touch contact associated with a particular region of the display device of the client computing entity. In embodiments, a threshold number of outcome interaction signals occurring associated with a first video stream of an interface streaming session as opposed to a second video stream of the interface streaming session may result in an altered rendering of the first video stream and the second video stream.

The term “stream interface” refers to an electronic interface, which may include multiple areas, where each area may be situated in relation to one or more other interface areas of the electronic interface. An interface area may be comprised of groupings of pixels, or may be defined according to coordinates of a display device configured to render the interface. A size of an interface may be adjusted according to parameters associated with the display device. An interface area may include one or more interface elements. For example, an interface element may include a visualization. In certain embodiments, an interface area may include one or more video elements, graphical elements, and/or textual elements. In certain embodiments, an interface area may be void of an interface element and/or a visualization. In certain embodiments, an interface area may include an interface interaction control element (e.g., an element with which a user may specifically interact to effect a specific and associated interface interaction signal to be transmitted for processing) and/or one or more other interactive interface elements.

The term “interface interaction signal identifier” refers to one or more items of data by which an interface interaction signal may be uniquely identified.

The term “video stream identifier” refers to refers to one or more items of data by which a video stream may be uniquely identified.

The term “audio stream identifier” refers to refers to one or more items of data by which an audio stream may be uniquely identified.

The term “real time” refers to signals being received and processed such that results are returned sufficiently quickly to affect the computing environment without significant delay. For example, in embodiments, an interface streaming session involves receiving real time interface interaction signals from a plurality of client computing devices, processing the interface interaction signals, and generating and transmitting interface elements or interface adjustments to the plurality of client computing devices based on the processed interface interaction signals such that the interface elements and/or interface adjustments are renderable by the plurality of client computing devices in substantially real time during the interface streaming session. Such real time processing and delivery of results ensures that user interaction with the interface streaming session is reflected within the interface streaming session while the user interactions remain meaningful.

The term “elapsed time” refers to a duration of network time between a first timestamp and a second timestamp. In embodiments, a first timestamp may be associated with a start of an interface streaming session while a second timestamp may be associated with an interface interaction signal received from a client computing entity participating in, rendering, or otherwise consuming the interface streaming session. In such embodiments, the elapsed time between the first timestamp and the second timestamp may be taken into account for one or more weight values associated with the interface interaction signal. In other embodiments, the first timestamp may be associated with a first interaction signal received from a client computing entity participating in, rendering, or otherwise consuming the interface streaming session while the second timestamp may be associated with a second, subsequent, interaction signal received from the client computing entity during the interface streaming session. In such embodiments, the elapsed time between the first timestamp and the second timestamp may be taken into account for one or more weight values associated with the second interface interaction signal.

The term “consumption count” refers to a number or count of client computing entities consuming or rendering an interface streaming session at a given timestamp associated with the interface streaming session. For example, if there are five (5) client computing entities participating in or rendering an interface streaming session at a first timestamp, then the consumption count at the first timestamp may be five (5). By way of further example, if there are ten (10) client computing entities participating in or rendering the interface streaming session at a second timestamp, then the consumption count at the second timestamp may be ten (10). It will be appreciated that, in embodiments, the consumption count excludes the client computing entities from which a first video stream, first audio stream, second video stream, and second audio stream of the interface streaming session originate. That is, if the first video stream and first audio stream originate from a first client computing entity and the second video stream and second audio stream originate from a second client computing entity, and there are five (5) other client computing entities (e.g., other than the first client computing entity and the second client computing entity) participating in or rendering an interface streaming session at a first timestamp, then the consumption count at the first timestamp may be five (5). Continuing with the same example, if there are ten (10) other client computing entities (e.g., other than the first client computing entity and the second client computing entity) participating in or rendering the interface streaming session at a second timestamp, then the consumption count at the second timestamp may be ten (10).

The term “aggregated interaction file” refers to computing resource configured for storing information representative of or associated with an interface streaming session. In embodiments, an aggregated interaction file is configured for storage in a repository and for later retrieval from the repository. In embodiments, while an interface streaming session may be comprised of multiple independent transmission streams (e.g., a first audio stream, a first video stream, a second audio stream, a second video stream, a third audio stream), the aggregated interaction file is a single resource containing the independent transmission streams of the interface streaming session for storage in a repository. In embodiments, an aggregated interaction file may be associated with an interface interaction signal data structure so that, when the aggregated interaction file is retrieved for later consumption by one more client computing entities, data from the interface interaction signal data structure may be extracted and utilized for synchronizing various interface elements overlaid on a rendering of the aggregated interaction file according to methods described herein.

The term “interface interaction signal data structure” refers to a data structure comprising one or more data records configured for storing data associated with interface interaction signals for a given interface streaming session. In certain embodiments, an interface interaction signal data structure comprises a plurality of data records, where each data record represents an individual interface interaction signal and contains metadata associated with the individual interface interaction signal. Examples of metadata associated with an interface interaction signal that may be contained within a data record of an interface interaction signal data structure may include an interface interaction signal timestamp (e.g., a point in network time during which the interface interaction signal was generated or occurred), a video stream identifier (e.g., one or more items of data uniquely identifying a video stream with which the interface interaction signal is associated, such that the interface interaction signal represents an electronic interaction with a rendering of the video stream), a client computing entity identifier or a user identifier (e.g., one or more items of data uniquely identifying either a client computing entity from which the interface interaction signal originated or a user associated with a client computing entity from which the interface interaction signal originated).

The term “transmission stream” refers to one or more items of data associated with an independent set of data for transmission such that the one or more items of data are transmitted as an independent stream separate from transmission of a different or distinct set of data. Multiple transmission streams may be transmitted during a given transmission opportunity period, and the multiple transmission streams may have common timestamps such that the data contained therein may be synchronously rendered at a destination in receipt of the multiple transmission streams. For example, an interface streaming session may have associated therewith a first set of data comprising a first video stream and a first audio stream that may have originated from a first client computing entity. The interface streaming session may also have associated therewith a second set of data comprising a second video stream and a second audio stream that may have originated from a second client computing entity. The interface streaming session may also have associated therewith a third set of data comprising a third audio stream that may have originated from a third client computing entity or remote server or remote computing device, where the third audio stream may comprise streaming audio representative of music for inclusion in a rendering of the first set of data and the second set of data. Further, the interface streaming session may also have associated therewith a fourth set of data comprising interface elements generated based on real-time interface interaction signals received from a plurality of client computing devices rendering and interacting with the first, second, and third sets of data. In such embodiments, each of the first, second, third, and fourth sets of data may be transmitted as independent transmission streams to each client computing device of a plurality of client computing devices associated with the interface streaming session. In yet other embodiments, the first set of data may be divided into multiple independent transmission streams, namely a transmission stream associated with the first audio stream and a transmission stream associated with the first video stream.

The term “transmission stream identifier” refers to one or more items of data by which a transmission stream may be uniquely identified.

### III. COMPUTER PROGRAM PRODUCTS, METHODS, AND COMPUTING ENTITIES

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations. Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. EXEMPLARY SYSTEM ARCHITECTURE

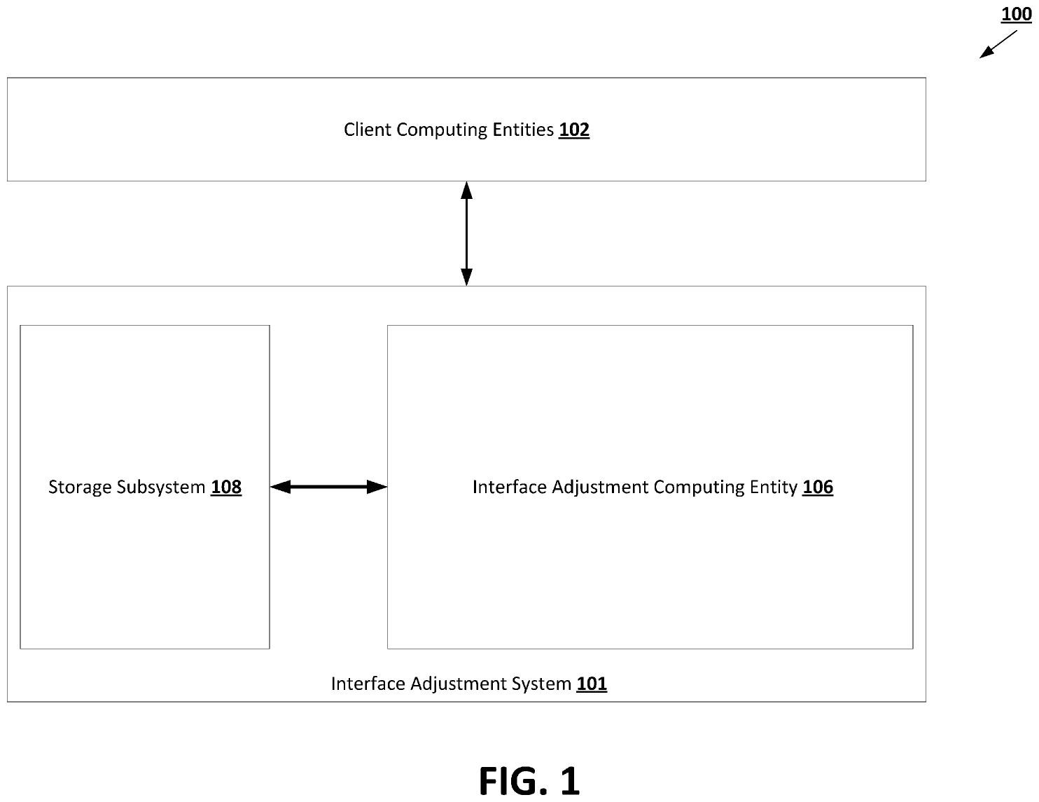

FIG. 1 is a schematic diagram of an example architecture 100 for use with embodiments of the present disclosure. The architecture 100 includes an interface adjustment system 101 configured to receive interface interaction signals from client computing entities 102, process the interface interaction signals to generate interface adjustments, provide the generated interface adjustments to the client computing entities 102, and adjust the presentation of video stream interface elements based on interface interaction signals.

In some embodiments, interface adjustment system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The interface adjustment system 101 may include a interface adjustment computing entity 106 and a storage subsystem 108. The interface adjustment computing entity 106 may be configured to receive interface interaction signals from client computing entities 102, process the interface interaction signals to generate interface adjustments, provide the generated interface adjustments to the client computing entities 102, and adjust the presentation of video stream interface elements based on interface interaction signals.

The storage subsystem 108 may be configured to store input data used by the interface adjustment computing entity 106 to perform interface adjustment as well as store and manage data used by the interface adjustment computing entity 106 to perform various crowd interface adjustment tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Interface Adjustment Computing Entity

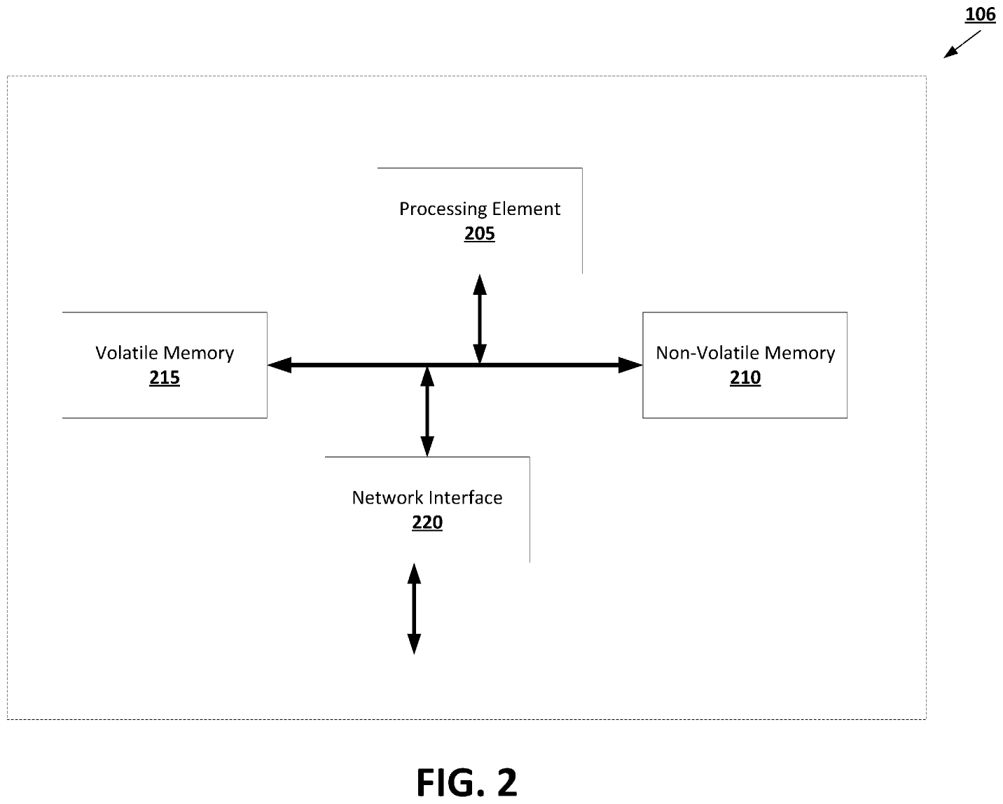

FIG. 2 provides a schematic of an interface adjustment computing entity 106 according to one embodiment of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the interface adjustment computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the interface adjustment computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the interface adjustment computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity—relationship model, object model, document model, semantic model, graph model, and/or the like.

In one embodiment, the interface adjustment computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the interface adjustment computing entity 106 with the assistance of the processing element 205 and operating system.

As indicated, in one embodiment, the interface adjustment computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the crowd interface adjustment computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the interface adjustment computing entity 106 may include, or be in communication with, one or more input elements, such as a keyboard input, a mouse input, a touch screen/display input, motion input, movement input, audio input, pointing device input, joystick input, keypad input, and/or the like. The interface adjustment computing entity 106 may also include, or be in communication with, one or more output elements (not shown), such as audio output, video output, screen/display output, motion output, movement output, and/or the like.

### Exemplary Client Computing Entity

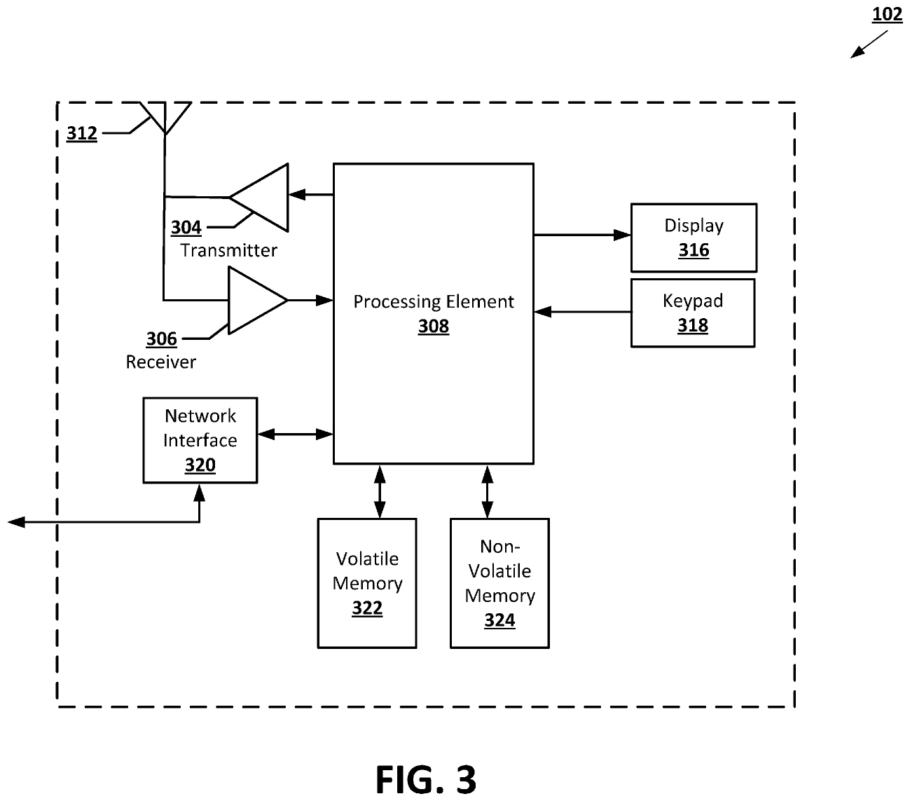

FIG. 3 provides an illustrative schematic representative of a client computing entity 102 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the interface adjustment computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the interface adjustment computing entity 106 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the interface adjustment computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the interface adjustment computing entity 106 and/or various other computing entities.

In another embodiment, the client computing entity 102 may include one or more components or functionality that are the same or similar to those of the interface adjustment computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. EXEMPLARY SYSTEM OPERATIONS

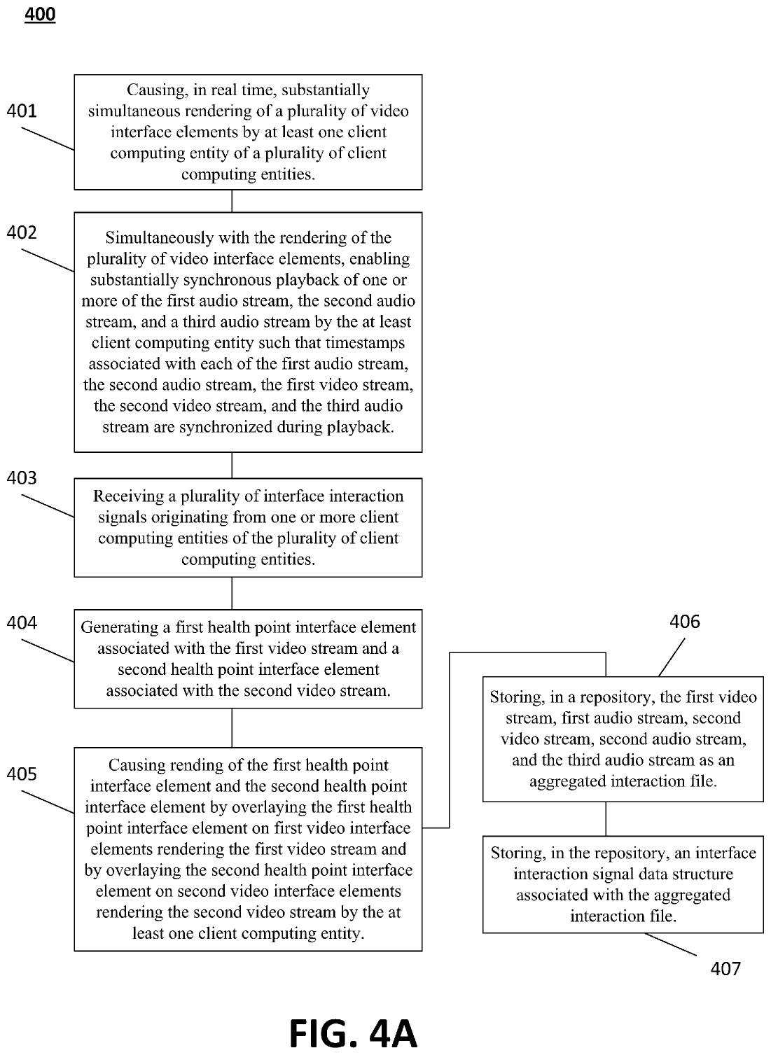

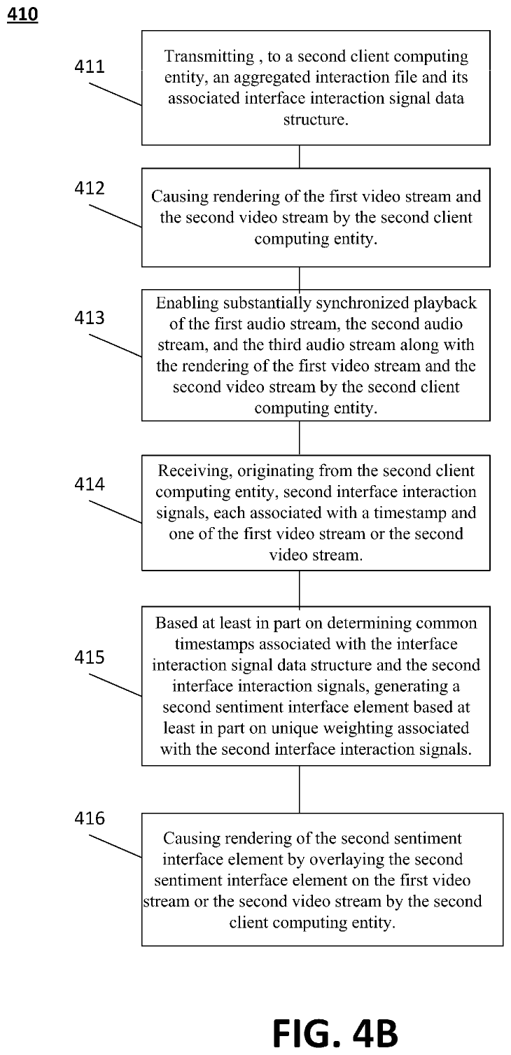

FIGS. 4A-4B depict example operations for use with embodiments of the present disclosure. In FIG. 4A, an example process 400 for dynamically adjusting interface elements based on synchronized interaction signals includes causing 401, by an apparatus (e.g., such as interface adjustment system 101 and/or interface adjustment computing entity 106), substantially simultaneous rendering of a plurality of video interface elements by at least one client computing entity (e.g., such as client computing entity 102) of a plurality of client computing entities (e.g., such as client computing entity 102). In embodiments, the plurality of video interface elements comprise a first video stream and a second video stream. In embodiments, the first video stream is associated with a first audio stream and the second video stream is associated with a second audio stream. In embodiments, causing rendering may include transmission of the first video stream and second video stream to the plurality of client computing entities such that the first video stream and second video stream are configured to be rendered by the plurality of client computing entities in accordance with parameters of each of the client computing entities (e.g., device type, display type, display size, operating system, etc.).

In embodiments, the example process 400 may further include, simultaneously with the rendering of the plurality of video interface elements, enabling 402, by the apparatus (e.g., such as interface adjustment system 101 and/or interface adjustment computing entity 106), substantially synchronous playback of one or more of the first audio stream, the second audio stream, and a third audio stream by the at least client computing entity (e.g., such as client computing entity 102) such that timestamps associated with each of the first audio stream, the second audio stream, the first video stream, the second video stream, and the third audio stream are synchronized during playback. In embodiments, enabling playback may include transmission of the first audio stream, the second audio stream, and the third audio stream to the plurality of client computing entities such that the first, second, and third audio stream are configured for playback by the client computing entities in accordance with parameters of the client computing entities. In embodiments, enabling playback may also include enabling the ability for any one or all of the audio streams to be muted by the client computing entities.

In embodiments, the example process 400 may further include receiving 403, by the apparatus (e.g., such as interface adjustment system 101 and/or interface adjustment computing entity 106), a plurality of interface interaction signals originating from one or more client computing entities (e.g., such as client computing entity 102) of the plurality of client computing entities (e.g., such as client computing entity 102). In embodiments, each interface interaction signal is associated with a user identifier associated with a client computing entity of the plurality of client computing entities, a timestamp of a plurality of timestamps associated with one of the first video stream or the second video stream, and a video stream identifier associated with either the first video stream or the second video stream.

In embodiments, the example process 400 may further include generating 404, by the apparatus (e.g., such as interface adjustment system 101 and/or interface adjustment computing entity 106), a first health point interface element associated with the first video stream and a second health point interface element associated with the second video stream. In embodiments, the first health point interface element is generated based at least in part on interface interaction signals associated with the first video stream, a remaining time duration, and a first health point interface element score, and wherein the second health point interface element is generated based at least in part on interface interaction signals associated with the second video stream, the remaining time duration, and a second health point interface element score.

In embodiments, the example process 400 may further include causing 405, by the apparatus (e.g., such as interface adjustment system 101 and/or interface adjustment computing entity 106), rendering of the first health point interface element and the second health point interface element by overlaying the first health point interface element on first video interface elements rendering the first video stream and by overlaying the second health point interface element on second video interface elements rendering the second video stream by the at least one client computing entity (e.g., such as client computing entity 102).

In embodiments, the example process 400 may further include storing 406, in a repository, the first video stream, first audio stream, second video stream, second audio stream, and the third audio stream as an aggregated interaction file.

In embodiments, the example process 400 may further include storing 407, in the repository, an interface interaction signal data structure associated with the aggregated interaction file. In embodiments, the interface interaction signal data structure comprises a plurality of records each storing data representative of an interface interaction signal associated with the aggregated interaction file.

In embodiments, the first health point interface score is generated based at least in part on a first health point count and the remaining time duration. In embodiments, the second health point interface score is generated based at least in part on a second health point count and the remaining time duration.

In embodiments, an example process may further include adjusting (not shown in FIG. 4A) by the apparatus (e.g., such as interface adjustment system 101 and/or interface adjustment computing entity 106), at a first timestamp, a first size of the first health point interface element based at least in part on a change in the first health point interface score. In embodiments, the change in the first health point interface score is generated based at least in part on additional interface interaction signals associated with the second video stream and their associated weight values, as well as a remaining time duration at the first timestamp.

In embodiments, an example process may further include adjusting (not shown in FIG. 4A) by the apparatus (e.g., such as interface adjustment system 101 and/or interface adjustment computing entity 106), at a second timestamp, a second size of the second health point interface element based at least in part on a change in the second health point interface score. In embodiments, the change in the second health point interface score is generated based at least in part on additional interface interaction signals associated with the first video stream and their associated weight values, as well as a remaining time duration at the second timestamp.

In embodiments, adjusting the first health point interface score is further based on a first number of interface interaction signals associated with the second video stream as well as a common timestamp, as well as weight values associated with each interface interaction signal of the first number of interface interaction signals. In embodiments, adjusting the second health point interface score is further based on a second number of interface interaction signals associated with the first video stream as well as a common timestamp, as well as weight values associated with each interface interaction signal of the second number of interface interaction signals.

In embodiments, a weight value for a given interface interaction signal at a given timestamp is generated based at least in part on a consumption count associated with the timestamp associated with the interface interaction signal.

In embodiments, the consumption count is based at least in part on a number of client computing entities rendering the first video stream and the second video stream during the timestamp.

In embodiments, the first video stream and the first audio stream originate from a first remote client computing entity and the second video stream and the second audio stream originate from a second remote client computing entity. In embodiments, the third audio stream is transmitted from a third party audio streaming server to the plurality of client computing entities.

In embodiments, the first video stream comprises a first frame sequence comprising a first plurality of video frames arranged in sequential order and each associated with a unique timestamp. In embodiments, the first audio stream comprises a first audio sequence comprising a first plurality of audio snippets arranged in a same sequential order as the first plurality of video frames and each associated with a unique timestamp. In embodiments, the second video stream comprises a second frame sequence comprising a second plurality of video frames arranged in sequential order and each associated with a unique timestamp. In embodiments, the second audio stream comprises a second audio sequence comprising a second plurality of audio snippets arranged in a same sequential order as the second plurality of video frames and each associated with a unique timestamp.

In embodiments, an interface interaction signal represents an electronic interaction with a rendering of the first video stream or the second video stream via a display device of a client computing entity. In embodiments, the electronic interaction represents a swipe or touch contact associated with a particular region of the display device of the client computing entity.

In embodiments, the apparatus is configured to receive, originating from the first remote client computing entity, the first video stream and the first audio stream. The apparatus may further be configured to receive, originating from the second remote client computing entity, the second video stream and the second audio stream. In embodiments, the apparatus may further be configured to transmit, to the at least one client computing entity, the first video stream and the first audio stream as a first transmission stream, the second video stream and the second audio stream as a second transmission stream, and the third audio stream as a third transmission stream.

In embodiments, the apparatus is further configured to receive, originating from the plurality of client computing entities, a plurality of outcome interaction signals. Based at least in part on the plurality of outcome interaction signals, the apparatus may be configured to cause the first video stream to cease rendering while continuing rendering of the second video stream.

In embodiments, the apparatus is further configured to receive, originating from the plurality of client computing entities, a plurality of outcome interaction signals. Based at least in part on the plurality of outcome interaction signals, the apparatus may be configured to cause the second video stream to cease rendering while continuing rendering of the first video stream.

In embodiments, the apparatus is further configured to establish a socket connection for communication with the plurality of client computing devices.

In FIG. 4B, an example process 410 for dynamically adjusting interface elements based on synchronized interaction signals (e.g., during what may be referred to as a replay of an interface streaming session as opposed to a live stream of the interface streaming session) may include transmitting 411, by the apparatus (e.g., such as interface adjustment system 101 and/or interface adjustment computing entity 106), to a second client computing entity (e.g., such as client computing entity 102), an aggregated interaction file and its associated interface interaction signal data structure.

In embodiments, the example process 410 may further include causing 412, by the apparatus (e.g., such as interface adjustment system 101 and/or interface adjustment computing entity 106), rendering of the first video stream and the second video stream by the second client computing entity (e.g., such as client computing entity 102).

In embodiments, the example process 410 may further include enabling 413, by the apparatus (e.g., such as interface adjustment system 101 and/or interface adjustment computing entity 106), substantially synchronized playback of the first audio stream, the second audio stream, and the third audio stream along with the rendering of the first video stream and the second video stream by the second client computing entity (e.g., such as client computing entity 102).

In embodiments, example process 410 may further include receiving 414, by the apparatus (e.g., such as interface adjustment system 101 and/or interface adjustment computing entity 106), originating from the second client computing entity (e.g., such as client computing entity 102), second interface interaction signals, each associated with a timestamp and one of the first video stream or the second video stream.

In embodiments, the example process 410 may further include, based at least in part on determining common timestamps associated with the interface interaction signal data structure and the second interface interaction signals, generating 415, by the apparatus (e.g., such as interface adjustment system 101 and/or interface adjustment computing entity 106), a second sentiment interface element based at least in part on unique weighting associated with the second interface interaction signals.

In embodiments, the example process 410 may further include, causing 416, by the apparatus (e.g., such as interface adjustment system 101 and/or interface adjustment computing entity 106), rendering of the second sentiment interface element by overlaying the second sentiment interface element on the first video stream or the second video stream by the second client computing entity (e.g., such as client computing entity 102).

In embodiments, the example process may further include adjusting (not shown in FIG. 4B), at a third timestamp, a third size of the first health point interface element based at least in part on a change in the first health point interface score. In embodiments, the change in the first health point interface score is generated based at least in part on second interface interaction signals associated with the second video stream and their associated weight values, as well as a remaining time duration at the third timestamp. In embodiments, the second interface interaction signals originated from the second client computing entity.

In embodiments, the example process may further include adjusting (not shown in FIG. 4B), at a fourth timestamp, a fourth size of the second health point interface element based at least in part on a change in the second health point interface score. In embodiments, the change in the second health point interface score is generated based at least in part on second interface interaction signals associated with the first video stream and their associated weight values, as well as a remaining time duration at the second timestamp. In embodiments, the second interface interaction signals originated from the second client computing entity.

In embodiments, health point interface elements may be recalibrated against a current result associated with the interface streaming session (e.g., with the aggregated interaction file) and the duration of the interface streaming session. For example, two streamers (e.g., a first client computing entity and a second client computing entity), one with a health point score of 100 (e.g., or 100 interface interaction signals) and the other with 50 (e.g., score or interaction signals). In such an example, when a next viewer (e.g., the second client computing entity) watching (e.g., consuming or rendering) the interface streaming session without triggering any interface interaction signals, the health point interface elements may display 50% difference at the end of the interface streaming session. However, embodiments may provide for ensuring extra percentage due to calibration for the losing streamer (e.g., the second client computing entity with a score of 50), so at the end of the interface streaming session the health point interface element may be x % vs x+50% in the above example. In such embodiments, the individual session associated with the second client computing entity provides for agreement or disagreement with a general consensus

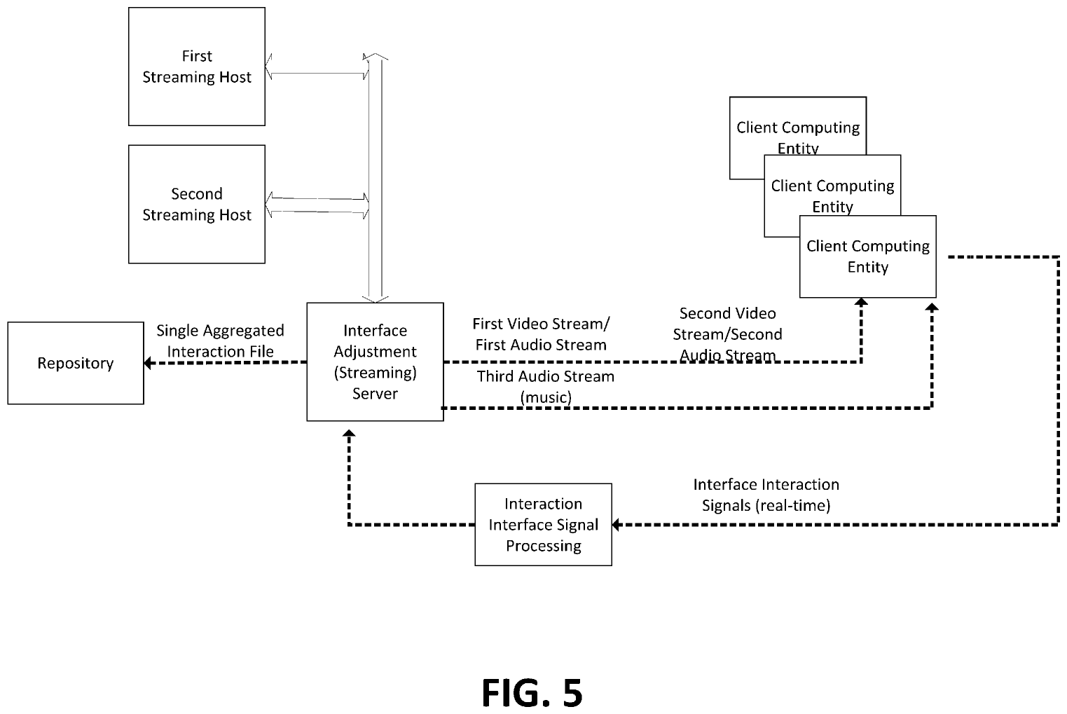

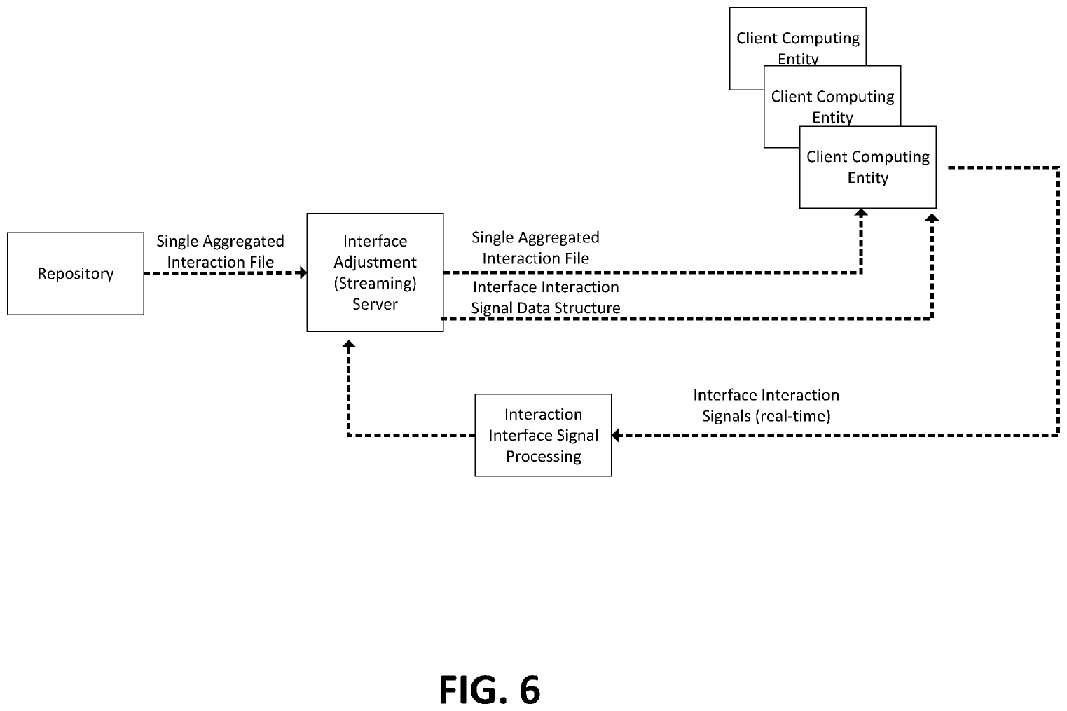

FIGS. 5-6 depict example data flow diagrams in accordance with embodiments of the present disclosure. In FIG. 5, data flow is associated with a live stream of an interface streaming session while in FIG. 6, data flow is associated with a replay or retrieval of an aggregated interaction file associated with an interface streaming session that has already occurred.

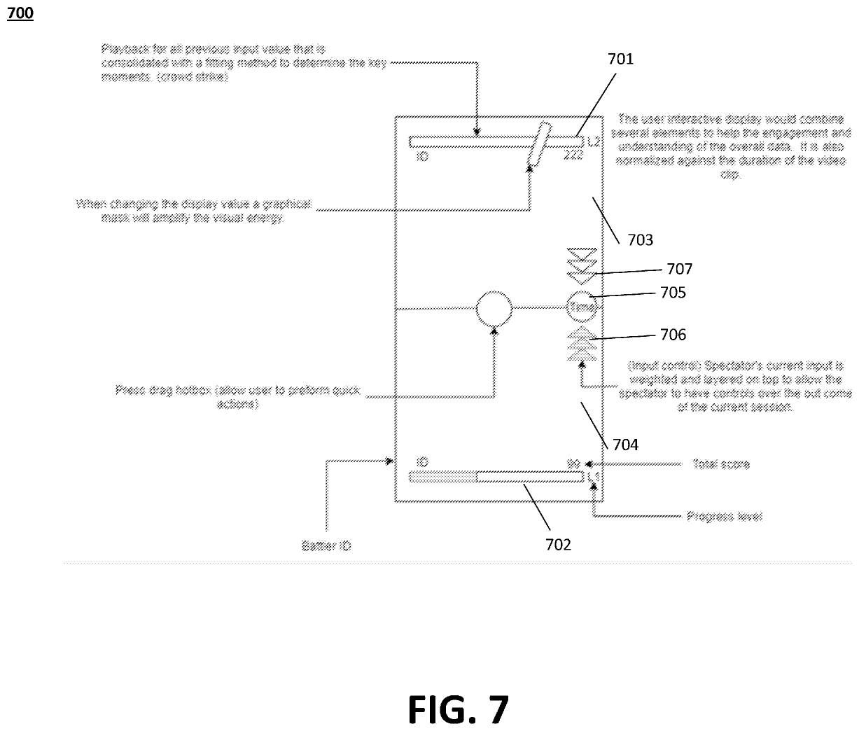

FIG. 7 depicts an example interface layout 700 for use with embodiments of the present disclosure. In FIG. 7, an upper portion or card or section 703 of the interface layout 700 may be associated, in certain embodiments, with a first video stream that may be rendered in the upper portion/card/section 703. In such embodiments, a first health point interface element 701 associated with the first video stream may be overlaid atop the rendering of the first video stream. Further, a lower portion or card or section 704 of the interface layout 700 may be associated, in certain embodiments, with a second video stream (e.g., separate and distinct from the first video stream) that may be rendered in the lower portion/card/section 704. In such embodiments, a second health point interface element 702 associated with the second video stream may be overlaid atop the rendering of the second video stream. An interface element 705 may render a visual representation of a remaining duration of the interface streaming session with which the interface layout 700 is associated or a current total duration (e.g., time elapsed during) the interface streaming session with which the interface layout 700 is associated. Interface elements 706 and 707 may provide for interaction, as described herein, with the interface by users associated with client computing devices rendering the interface layout 700.

It will be appreciated that, while FIG. 7 and other example interfaces presented herein depict interfaces comprising an apparent stacked configuration of a first video stream and a second video stream such that a first video stream may be rendered within an upper portion of an interface while a second video stream may be rendered within a lower portion of the interface, embodiments herein provide for dynamic configurability of interfaces such that first and second video streams may be rendered in a side by side configuration as opposed to an upper and lower configuration. Further, embodiments herein provide for vertical, horizontal, portrait, or landscape orientation of interfaces, dependent upon device type, device orientation (e.g., which may switch on the fly), screen size, screen type, operating system, and other parameters.

It will further be appreciated that, while FIG. 7 and other example interfaces presented herein depict interfaces comprising health point interface elements that appear horizontally on the interfaces and that render health point interface scores in a horizontal manner (e.g., increasing or decreasing from left to right or vice versa), it is within the scope of the present disclosure to have interfaces comprising health point interface elements that appear vertically on the interfaces and that render health point interface scores in a vertical manner (e.g., increasing or decreasing from top to bottom or vice versa).

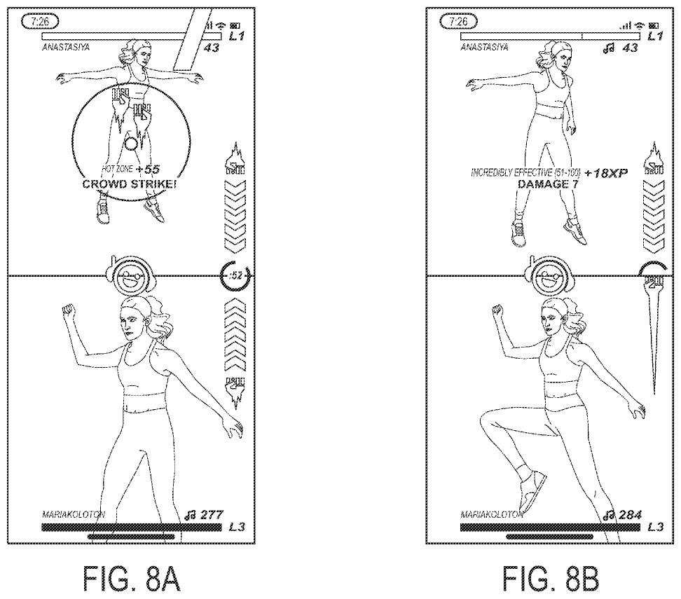

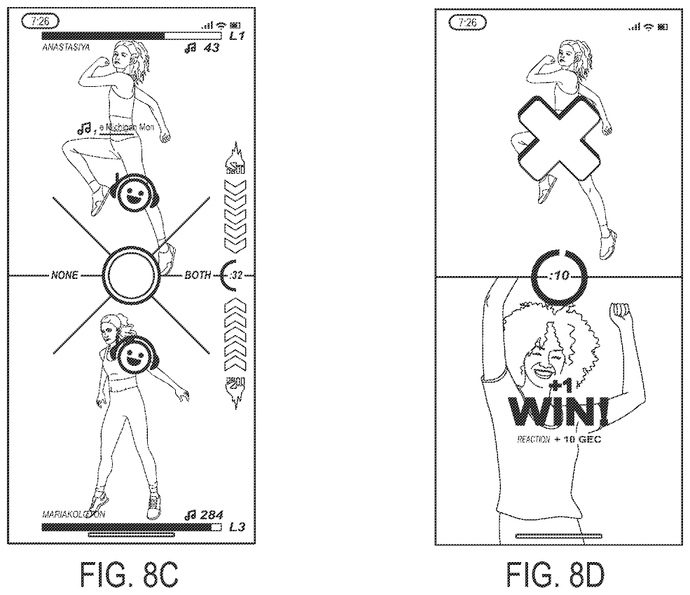

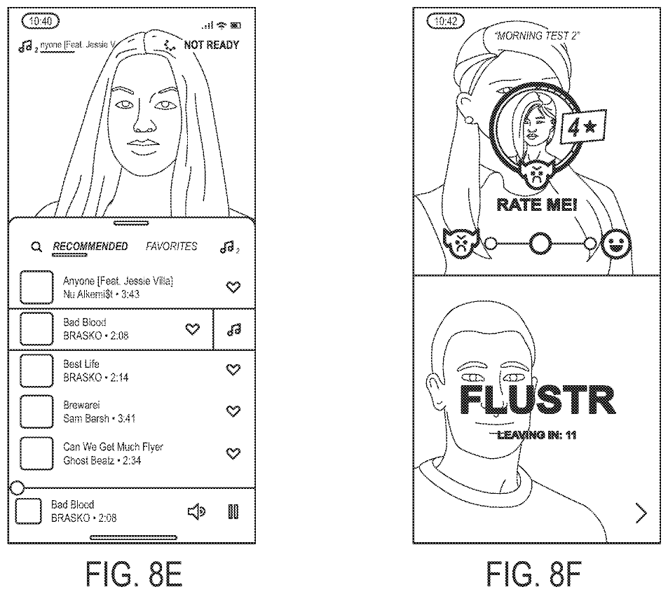

FIGS. 8A-8F depict example interfaces rendered according to embodiments of the present disclosure. In FIGS. 8A-8F, a spectator or consumer of an interface streaming session may consume multiple synchronized streaming video streams as well as audio streams and interact with the interfaces as described herein. Also in FIGS. 8A-8F, a user of a client computing entity from which a video stream as well as an audio stream of an interface streaming session is initiated may interact with a series of interfaces as described herein.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. An apparatus comprising at least one processor and at least one non-transitory computer-readable storage medium for storing instructions that, with the at least one processor, configure the apparatus to:
cause, in real time, substantially simultaneous rendering of a plurality of video interface elements by at least one client computing entity of a plurality of client computing entities, wherein the plurality of video interface elements comprise a first video stream and a second video stream, wherein the first video stream is associated with a first audio stream and the second video stream is associated with a second audio stream;
simultaneously with the rendering of the plurality of video interface elements, enable substantially synchronous playback of one or more of the first audio stream, the second audio stream, and a third audio stream by the at least client computing entity such that timestamps associated with each of the first audio stream, the second audio stream, the first video stream, the second video stream, and the third audio stream are synchronized during playback;
receive a plurality of interface interaction signals originating from one or more client computing entities of the plurality of client computing entities, wherein each interface interaction signal is associated with a user identifier associated with a client computing entity of the plurality of client computing entities, a timestamp of a plurality of timestamps associated with one of the first video stream or the second video stream, and a video stream identifier associated with either the first video stream or the second video stream;
generate a first health point interface element associated with the first video stream and a second health point interface element associated with the second video stream, wherein the first health point interface element is generated based at least in part on interface interaction signals associated with the first video stream, a remaining time duration, and a first health point interface element score, and wherein the second health point interface element is generated based at least in part on interface interaction signals associated with the second video stream, the remaining time duration, and a second health point interface element score; and
cause rendering of the first health point interface element and the second health point interface element by overlaying the first health point interface element on first video interface elements rendering the first video stream and by overlaying the second health point interface element on second video interface elements rendering the second video stream by the at least one client computing device.

2. The apparatus of claim 1, wherein the first health point interface score is generated based at least in part on a first health point count and the remaining time duration and wherein the second health point interface score is generated based at least in part on a second health point count and the remaining time duration.

3. (canceled)

4. The apparatus of claim 2, further configured to:
adjust, at a first timestamp, a first size of the first health point interface element based at least in part on a change in the first health point interface score, wherein the change in the first health point interface score is generated based at least in part on additional interface interaction signals associated with the second video stream and their associated weight values, as well as a remaining time duration at the first timestamp.

5. The apparatus of claim 4, further configured to:
adjust, at a second timestamp, a second size of the second health point interface element based at least in part on a change in the second health point interface score, wherein the change in the second health point interface score is generated based at least in part on additional interface interaction signals associated with the first video stream and their associated weight values, as well as a remaining time duration at the second timestamp.

6. The apparatus of claim 4, wherein adjusting the first health point interface score is further based on a first number of interface interaction signals associated with the second video stream as well as a common timestamp, as well as weight values associated with each interface interaction signal of the first number of interface interaction signals.

7. The apparatus of claim 5, wherein adjusting the second health point interface score is further based on a second number of interface interaction signals associated with the first video stream as well as a common timestamp, as well as weight values associated with each interface interaction signal of the second number of interface interaction signals.

8. The apparatus of any of claim 7, wherein a weight value for a given interface interaction signal at a given timestamp is generated based at least in part on a consumption count associated with the timestamp associated with the interface interaction signal.

9. The apparatus of claim 8, wherein the consumption count is based at least in part on a number of client computing entities rendering the first video stream and the second video stream during the timestamp.

10. The apparatus of claim 1, wherein the first video stream and the first audio stream originate from a first remote client computing entity and the second video stream and the second audio stream originate from a second remote client computing entity.

11. The apparatus of claim 1, wherein the third audio stream is transmitted from a third party audio streaming server to the plurality of client computing entities.

12. The apparatus of claim 1, wherein the first video stream comprises a first frame sequence comprising a first plurality of video frames arranged in sequential order and each associated with a unique timestamp.

13. The apparatus of claim 12, wherein the first audio stream comprises a first audio sequence comprising a first plurality of audio snippets arranged in a same sequential order as the first plurality of video frames and each associated with a unique timestamp.

14. The apparatus of claim 1, wherein the second video stream comprises a second frame sequence comprising a second plurality of video frames arranged in sequential order and each associated with a unique timestamp.

15. The apparatus of claim 14, the second audio stream comprises a second audio sequence comprising a second plurality of audio snippets arranged in a same sequential order as the second plurality of video frames and each associated with a unique timestamp.

16. The apparatus of claim 1, wherein an interface interaction signal represents an electronic interaction with a rendering of the first video stream or the second video stream via a display device of a client computing entity.

17. The apparatus of claim 16, wherein the electronic interaction represents a swipe or touch contact associated with a particular region of the display device of the client computing entity.

18. The apparatus of claim 1, further configured to:
store, in a repository, the first video stream, first audio stream, second video stream, second audio stream, and the third audio stream as an aggregated interaction file; and
store, in the repository, an interface interaction signal data structure associated with the aggregated interaction file, wherein the interface interaction signal data structure comprises a plurality of records each storing data representative of an interface interaction signal associated with the aggregated interaction file.

19. The apparatus of claim 18, further configured to:
transmit, to a second client computing entity, the aggregated interaction file and the interface interaction signal data structure;
cause rendering of the first video stream and the second video stream by the second client computing entity; and
enable substantially synchronized playback of the first audio stream, the second audio stream, and the third audio stream along with the rendering of the first video stream and the second video stream by the second client computing entity.

20. The apparatus of claim 19, further configured to:
receive, originating from the second client computing entity, second interface interaction signals, each associated with a timestamp and one of the first video stream or the second video stream;
based at least in part on determining common timestamps associated with the interface interaction signal data structure and the second interface interaction signals, generate a second sentiment interface element based at least in part on unique weighting associated with the second interface interaction signals; and
cause rendering of the second sentiment interface element by overlaying the second sentiment interface element on the first video stream or the second video stream by the second client computing entity.

21. The apparatus of claim 4, further configured to:
receive, originating from the first remote client computing entity, the first video stream and the first audio stream;
receive, originating from the second remote client computing entity, the second video stream and the second audio stream; and
transmit, to the at least one client computing entity, the first video stream and the first audio stream as a first transmission stream, the second video stream and the second audio stream as a second transmission stream, and the third audio stream as a third transmission stream.

22. The apparatus of claim 1, further configured to:
receive, originating from the plurality of client computing entities, a plurality of outcome interaction signals; and
based at least in part on the plurality of outcome interaction signals, cause the first video stream to cease rendering while continuing rendering of the second video stream.

23. The apparatus of claim 1, further configured to:
receive, originating from the plurality of client computing entities, a plurality of outcome interaction signals; and
based at least in part on the plurality of outcome interaction signals, cause the second video stream to cease rendering while continuing rendering of the first video stream.

24-28. (canceled)
